(19) United States
(12) Patent Application Publication
(10) Pub. No.: US 2012/0066639 A1
(43) Pub. Date: Mar. 15, 2012

(54) SCROLLING DEVICE COLLECTION ON AN INTERFACE

(75) Inventor: Jim Hunter, Sunnyvale, CA (US)

(73) Assignee: MOTOROLA MOBILITY, INC., Libertyville, IL (US)

(21) Appl. No.: 13/228,084

(22) Filed: Sep. 8, 2011

Related U.S. Application Data
(60) Provisional application No. 61/382,080, filed on Sep. 13, 2010.

(51) Int. Cl. G06F 3/048

(52) U.S. Cl. 715/784

(57) ABSTRACT

In one embodiment, a method includes receiving a selection of a set of devices. A scrolling collection is generated using the set of devices where the set of devices being available for control through an interface. The method scrolls through devices in the set of devices where the scrolling includes: determining a device in the set of devices; determining a control for the determined device; and displaying the determined device and the determined control on the interface. The determined device is controllable through the interface using the determined control while being displayed and devices in the set of devices other than the displayed determined device are not displayed on the interface.

### CROSS REFERENCE TO RELATED APPLICATIONS

The present application claims priority to U.S. Provisional App. No. 61/382,080 for “Device Monitoring in Slide Show Format” filed Sep. 13, 2010, the contents of which is incorporated herein by reference in their entirety.

### BACKGROUND

A user may control different devices using a user interface. For example, televisions, lights, thermostats, and other electronic devices may be controlled in a household. The user interface often includes a long list of devices. The user has to navigate through the list to select devices and control the devices serially. Thus, if the user wants to perform multiple actions to control multiple devices, each device is selected one at a time and the action is applied. For example, the user may want to turn a bedroom light and a hallway light off The user would select the bedroom light and turn the bedroom light off. Then, the user would select the hallway light and turn the hallway light off Also, the interface may display controls for the devices that may be complicated and hard for a user to determine which control to apply.

In another situation, the user interface may have limited screen space and cannot display all possible devices that can be controlled. The user may manually scroll through the interface to view different devices to control. Manually scrolling through a long list of devices may be inconvenient and time consuming

### SUMMARY

In one embodiment, a method includes receiving a selection of a set of devices. A scrolling collection is generated using the set of devices where the set of devices being available for control through an interface. The method scrolls through devices in the set of devices where the scrolling includes: determining a device in the set of devices; determining a control for the determined device; and displaying the determined device and the determined control on the interface. The determined device is controllable through the interface using the determined control while being displayed and devices in the set of devices other than the displayed determined device are not displayed on the interface.

In one embodiment, a non-transitory computer-readable storage medium is provided containing instructions for controlling a computer system to be operable to: receive a selection of a set of devices; generate a scrolling collection using the set of devices, the set of devices being available for control through an interface; scroll through devices in the set of devices, wherein scrolling comprises: determine a device in the set of devices; determine a control for the determined device; and display the determined device and the determined control on the interface, the determined device being controllable through the interface using the determined control while being displayed, wherein devices in the set of devices other than the displayed determined device are not displayed on the interface.

In one embodiment, an apparatus including one or more computer processors and a computer-readable storage medium is provided. The computer readable medium includes instructions for controlling the one or more computer processors to be operable to: receive a selection of a set of devices; generate a scrolling collection using the set of devices, the set of devices being available for control through an interface; scroll through devices in the set of devices, wherein scrolling comprises: determine a device in the set of devices; determine a control for the determined device; and display the determined device and the determined control on the interface, the determined device being controllable through the interface using the determined control while being displayed, wherein devices in the set of devices other than the displayed determined device are not displayed on the interface.

The following detailed description and accompanying drawings provide a more detailed understanding of the nature and advantages of the present invention.

### BRIEF DESCRIPTION OF THE DRAWINGS

FIG. 1 depicts an example of a computing device that is used to control devices according to one embodiment.

FIG. 2 depicts an example of a viewing area in a user interface after scrolling is performed according to one embodiment.

FIG. 3 depicts an example of navigation between groups according to one embodiment.

FIG. 4 shows an example of the scrolling from right to left according to one embodiment.

FIG. 5 shows an example of clustering of devices according to one embodiment.

FIG. 6 depicts an example of selecting devices for a scrolling collection according to one embodiment.

FIG. 7 shows an example of the viewing area for a scrolling collection according to one embodiment.

FIG. 8 shows a next device in the viewing area according to one embodiment.

FIG. 9 depicts a simplified flowchart of a method for generating a scrolling collection of devices according to one embodiment.

FIG. 10 depicts a more detailed example of the computing device according to one embodiment.

FIG. 11 shows an example of distributing scrolling collections according to one embodiment.

FIG. 12 shows an example of a user interface using a camera feed as a background according to one embodiment.

FIG. 13 depicts a simplified system according to one embodiment.

### DETAILED DESCRIPTION

Described herein are techniques for a device control interface. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

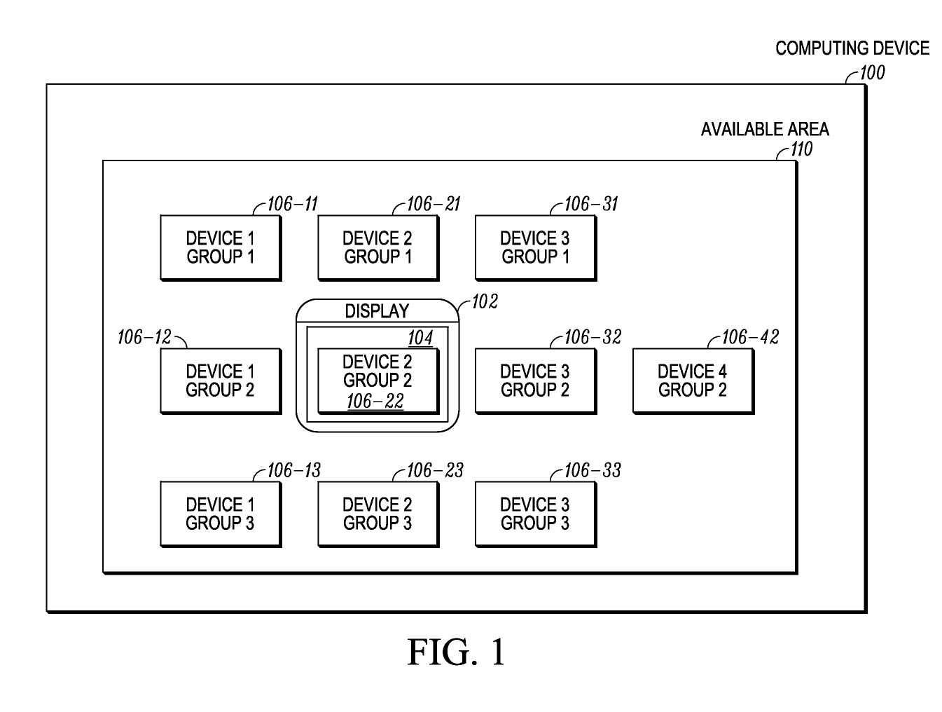

FIG. 1 depicts an example of a computing device 100 that is used to control devices 106 according to one embodiment. Computing device 100 includes a graphical user interface 102. An available area 110 shows a conceptual view of devices 106 that are available for control and access. Interface 102 includes a viewing area 104 that displays a device 106 to a user. Other devices 106 may be located in an off-screen area, that is, devices 106 in the off-screen area are not displayed to the user. When the term “device” is used, device may mean an icon, name, or other display notation that is used to represent a physical or virtual device that can be controlled. For example, devices 106 include items that may be found in a location, such as a home, business, or other area. Devices include physical devices, such as lights, televisions, appliances, and thermostats, and virtual devices, such as applications, content, music, and content feeds. Each device 106 may display different information.

A user may select devices 106 for inclusion in a scrolling collection. The scrolling collection organizes devices 106 in a manner that allows the user to view a portion of devices 106 in viewing area 104 at a time. Also, automatic scrolling of devices 106 in the scrolling collection is provided. For example, a slide show that is scrolled using a timer may be used. Also, the scrolling may be performed manually by scraping (e.g., a selection to move to the right or left using touch), selecting a control to move to the right or left, or based on an event.

The scrolling collection may include groups of devices 106. For example, in FIG. 1, three groups (Groups 1, 2, and 3) have been chosen. In one embodiment, when a group is being displayed in the scrolling collection, only devices 106 in that group are scrolled. A user may also navigate among groups to display devices 106 from different groups.

User interface 102 is currently displaying a device 106-22, which is in group 2. Group 2 also contains devices 106-12, 106-32, and 106-42. The scrolling of these devices 106 in group 2 is performed to allow a user to control a group of devices 106 in a sequential manner. For example, based on a timer, a device 106 shown in viewing area 104 changes at each time interval. Also, the user may manually determine which device 106 is displayed in viewing area 104 by scraping the screen to the right or left or by selecting a navigation control to move the screen right or left.

Devices 106 in available area 110 are available for control by the user. When a device 106 is displayed in viewing area 104, the user may apply a control to device 106. For example, if device 106-22 is a “light”, the user may turn the light on and off using a control (not shown). Devices 106 in the off-screen area may not be controlled. However, in other embodiments, controls selected for a displayed device 106 may be applied to devices 106 in off-screen area (e.g., to other devices 106 in the same group).

The state of devices 106 may be changing. For example, a camera may be receiving a content feed, a light may be turned on and off, or a thermostat setting may be changed. In one embodiment, the state of devices 106 whether devices 106 are in viewing area 104 or in the off-screen area is updated. The states may be updated dynamically because the user may want to scroll to a device 106 in the off-screen area and be able to view the state instantaneously. In one example of a state change, the user may be viewing a scrolling collection on a device 106 that can be controlled. The user may use another device 106-21 to control device 106-22 in the scrolling collection. When the change is made for device 106-22, then the state change is shown in interface 102 for device 106-22.

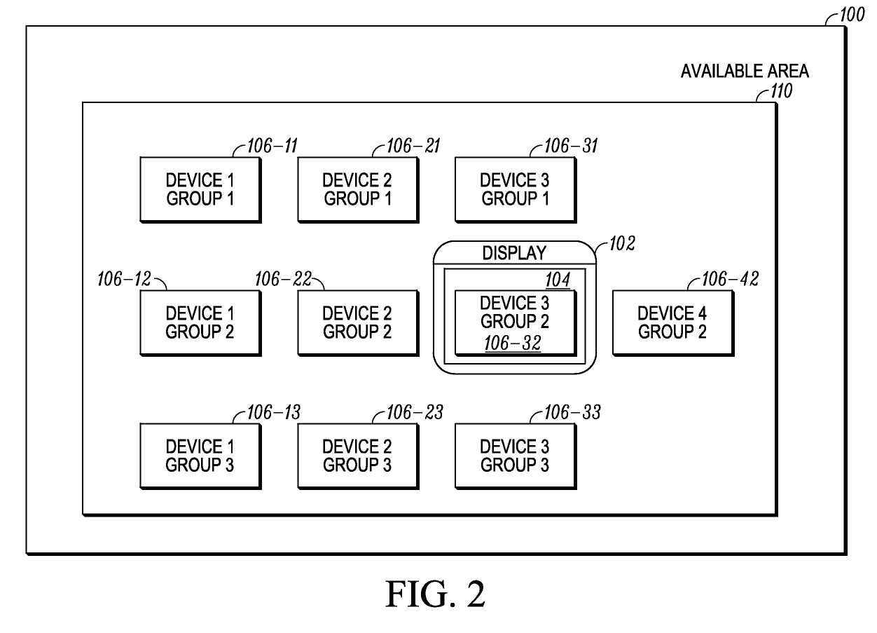

When a scrolling occurs, a device 106 displayed in viewing area 104 may change. FIG. 2 depicts an example of viewing area 104 in user interface 102 after scrolling is performed according to one embodiment. As shown, device 106-32 is shown in viewing area 104 and device 106-22 has moved to the off-screen area. As mentioned above, the state of device 106-32 was dynamically updated while device 106-32 was in the off-screen area. When the scrolling occurs, device 106-32 shows the updated state. A user can then control device 106-32.

By allowing scrolling of collections of devices 106, user interface 102 may be simplified. For example, instead of having a long list of devices 106 in which a user has to navigate through, devices 106 may be grouped into a collection that a user wants to control together. Additionally, user interface 102 is simplified by displaying a portion (e.g., one) of devices 106 in the scrolling collection at a time and scrolling through devices 106. Further, if a user is not actively controlling devices 106, but would like to see the current state of devices 106, the scrolling allows a user to passively see current states of devices 106.

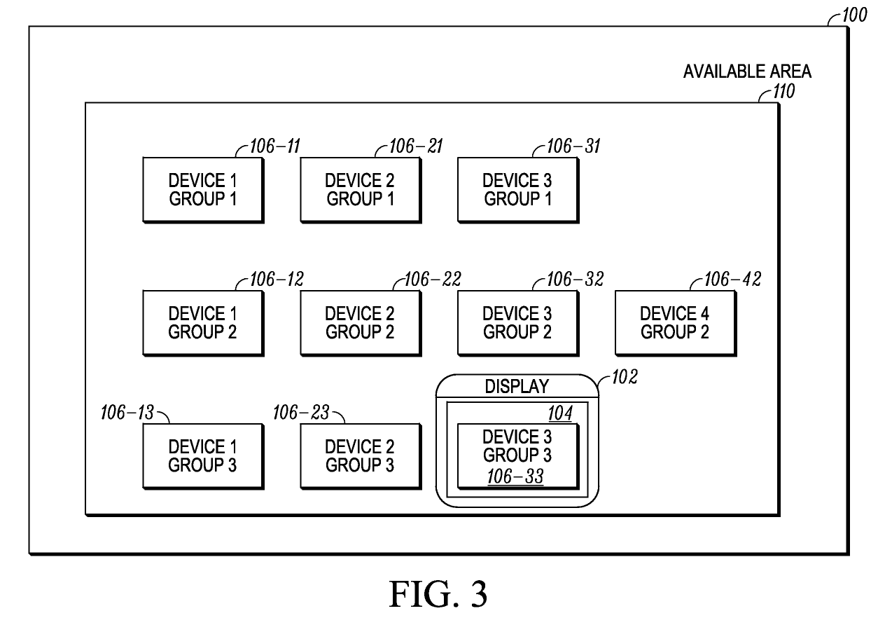

The scrolling collection may display devices 106 only in a current group of devices 106. The user may also navigate between groups. FIG. 3 depicts an example of navigation between groups according to one embodiment. As shown, a user has navigated from Group 2 to Group 3 and device 106-33 is displayed in viewing area 104. In one embodiment, a position in the scrolling collection of the previous group is used to determine which device 106 to display in the new group. For example, Device 3 was being displayed in the previous group and Device 3 is displayed in the new group. However, the position to display may be changed in the new group, such as device 106-13 may be displayed in viewing area 104 when the user switches groups. Also, a closest position may be displayed if the position in the previous group does not exist in the new group (e.g., Device 3 is displayed in Group 3 if Device 4 in Group 2 was being displayed).

The user may now control device 106-33 when device 106-33 is displayed in user interface 102. The state of device 106-33 has also been updated while device 106-33 was in the non-viewing area. Thus, the user sees the updated state when the user changes groups.

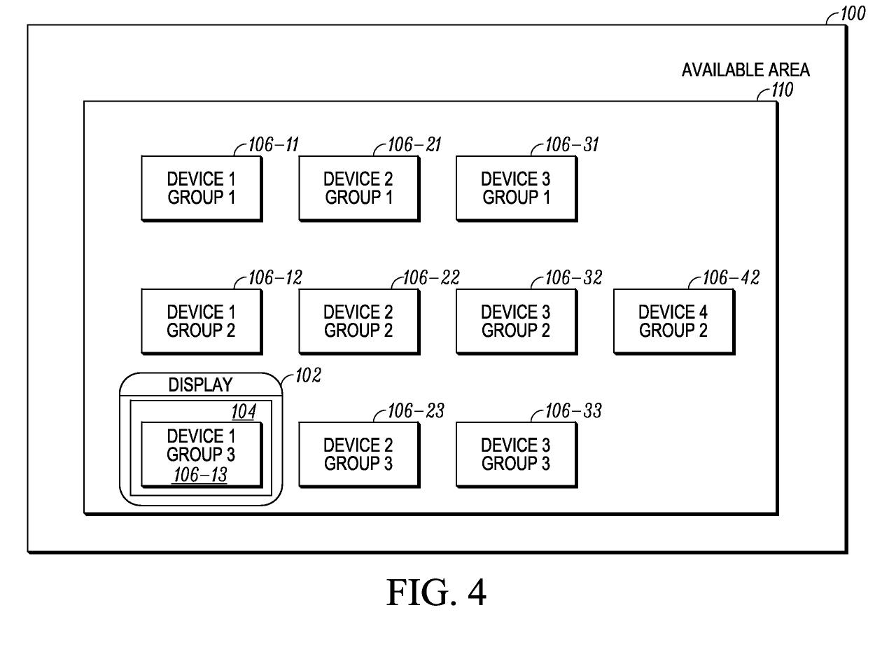

Devices 106 in group 3 are also scrolled through in sequence. For example, device 106-13 may be displayed next. FIG. 4 shows an example of the scrolling from right to left according to one embodiment. As shown, device 106-13 is now displayed in viewing area 104.

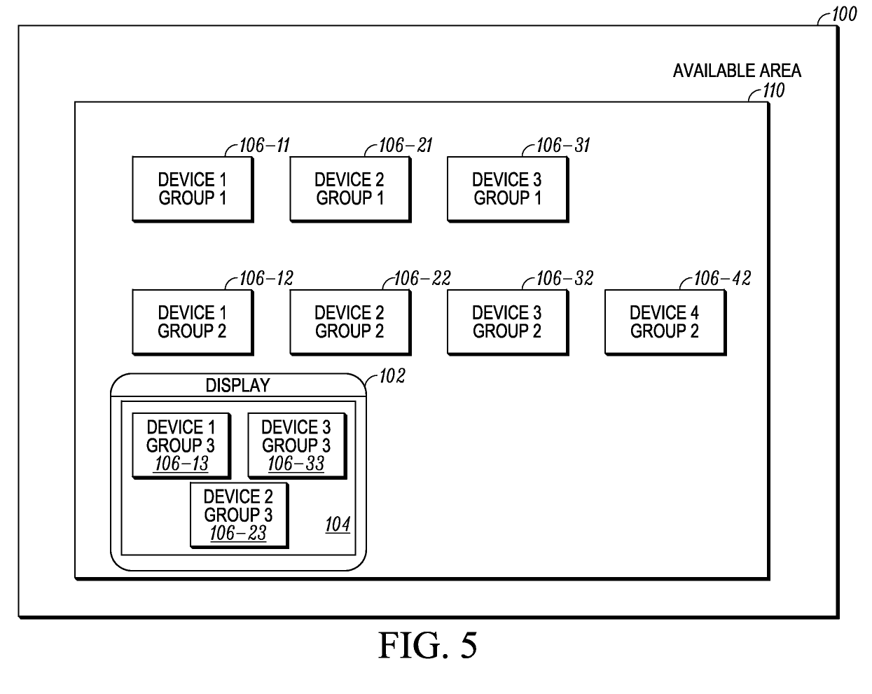

A cluster command may also be used. For example, the user may desire to cluster a group of devices 106 in viewing area 104. For example, a “pinch” action may be used to cluster all devices 106 in a group currently being scrolled through in viewing area 104. Also, a user may select a device 106 and devices 106 of a similar type (e.g., including a similar controllable feature) may be clustered in viewing area 104. FIG. 5 shows an example of clustering of devices 106 according to one embodiment. As shown, device 106-13, device 106-23, and device 106-33 have been clustered together in viewing area 104. A user may now control all three devices 106 at once if a common control exists. For example, the user may select all three devices 106 and turn them on and off

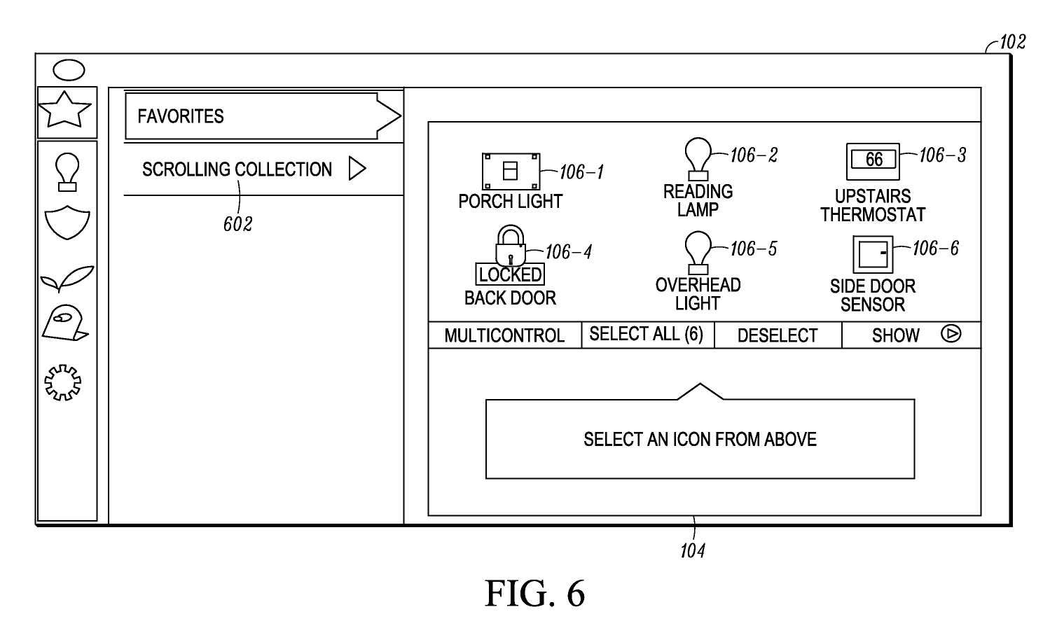

A more detailed example of viewing area 104 will now be described. FIG. 6 depicts an example of selecting devices 106 for a scrolling collection according to one embodiment. As shown, devices 106-1-106-6 have been selected for a scrolling collection. Devices 106 may be of a different type and include a porch light, reading lamp, upstairs thermostat, a back door lock, an overhead light, and a side door sensor. A user may generate a scrolling collection by selecting a scrolling collection command 602.

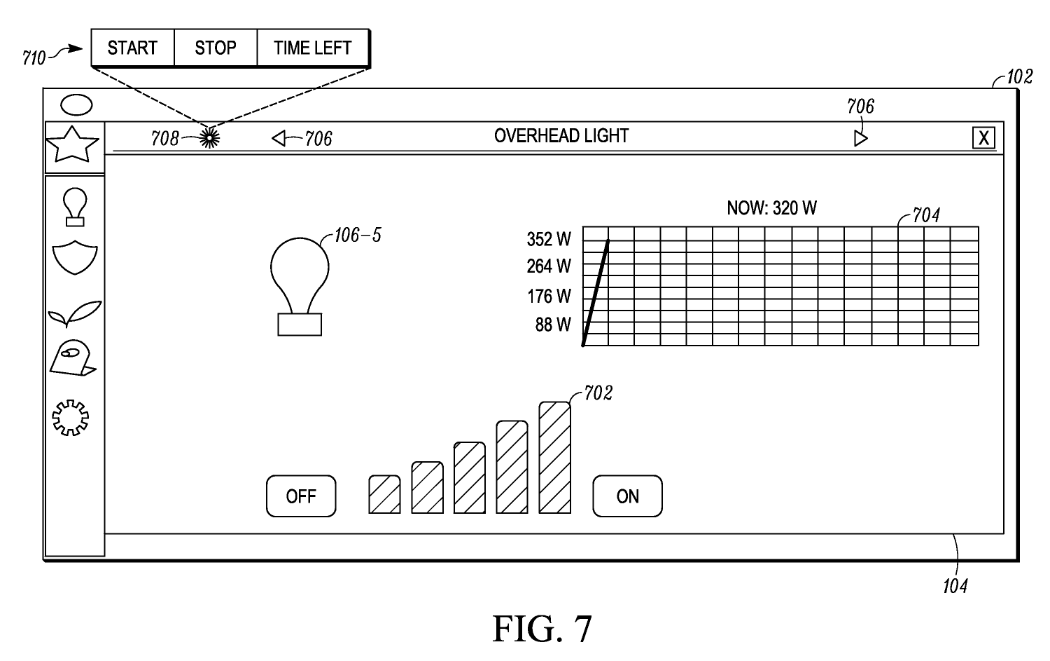

FIG. 7 shows an example of viewing area 104 for a scrolling collection according to one embodiment. When scrolling collection command 602 is selected, devices 106 that were grouped together in FIG. 6 are used to generate a scrolling collection. In one example, device 106-5, an overhead light, is displayed in viewing area 104. A control 702 is also displayed to allow device 106-5 to be controlled. For example, a user can turn the overhead light on and off Additional characteristics may also be shown. For example, a profile of the power usage of the overhead light is shown at 704. This profile may be updated in real-time whether or not light 106-5 is shown in viewing area 104 or in the off-screen area. Scrolling controls 706 may also be used to scroll through the scrolling collection.

Also, the scrolling collection may scroll to another device 106 after a time interval has passed. For example, an automatic timer control 708 may be used to display a timer control menu 710. A user may select timer control 708 to have timer control menu 710 displayed. Timer commands, such as “Start” and “Stop” may be used to start and stop the automatic scrolling. Also, timer control menu 710 may show the “time left”, which is the amount of time until a new device 106 will be shown. The amount of time for scrolling between devices 106 may also be adjusted.

Scrolling may also be performed based on an event detected at a device 106. For example, For example, energy use for device 106-5 may be monitored. When the energy use reaches a threshold while in device 106-5 is in the scrolling collection, device 106-5 is slid into viewing area 104 to display device 106-5. This alerts the user immediately that there is an issue.

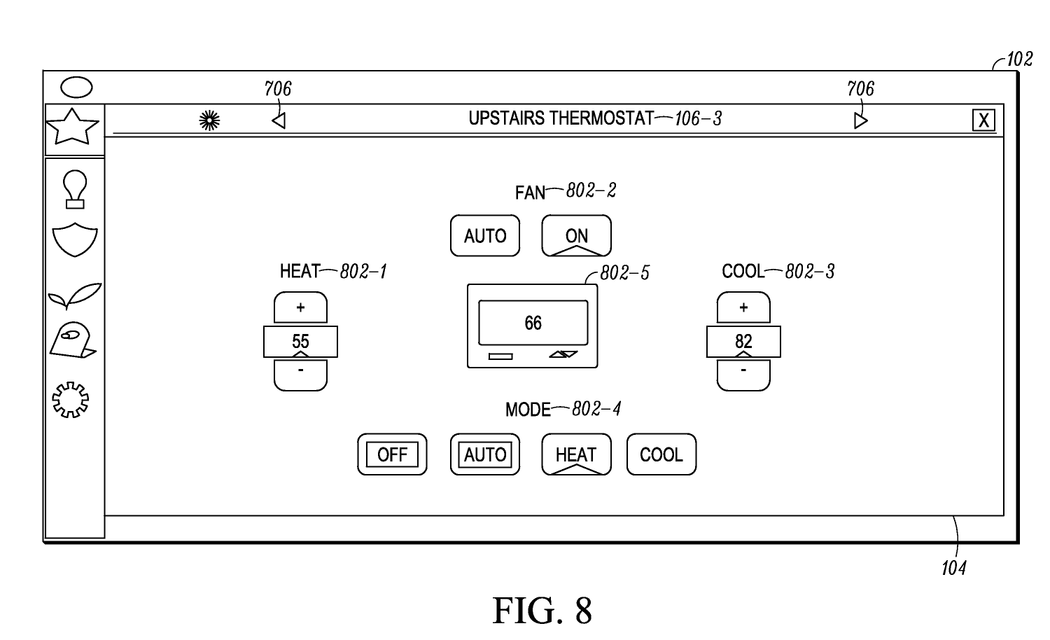

FIG. 8 shows a next device 106-3 in viewing area 104 according to one embodiment. As shown, device 106-3 is an upstairs thermostat. Controls 802-1-802-5 allow a user to control the upstairs thermostat. Also, real-time state information in control 802-5 has been updated for the upstairs thermostat. For example, the current temperature at the upstairs thermostat is 66° F. This temperature may be updated in real-time when the upstairs thermostat is in the viewing area 104 or in an off-screen area.

Control of devices 106 may be simplified because controls are displayed for only devices 106 being displayed. In one embodiment, each “slide” of the scrolling collection may include a control for a single device 106.

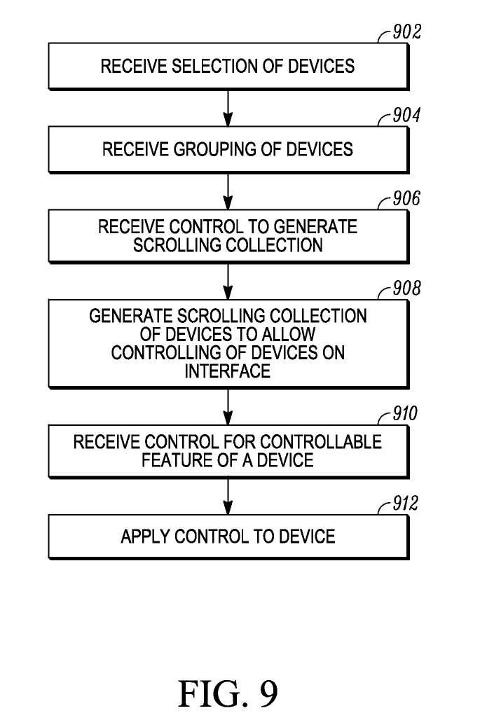

FIG. 9 depicts a simplified flowchart 900 of a method for generating a scrolling collection of devices 106 according to one embodiment. At 902, a selection of devices 106 is received. For example, a user may select multiple devices 106. At 904, a grouping of devices 106 is received. Thus, a user may select different devices 106 and also group them together into different groups.

At 906, a command to generate a scrolling collection is received. At 908, the scrolling collection of devices 106 is generated to allow controlling of devices 106 on user interface 102. For example, a single device 106 may be displayed in viewing area 104.

At 910, a control for controlling a controllable feature of a device 106 being displayed in viewing area 104 is received. The control may be displayed in viewing area 104. At 912, the control is automatically applied to device 106.

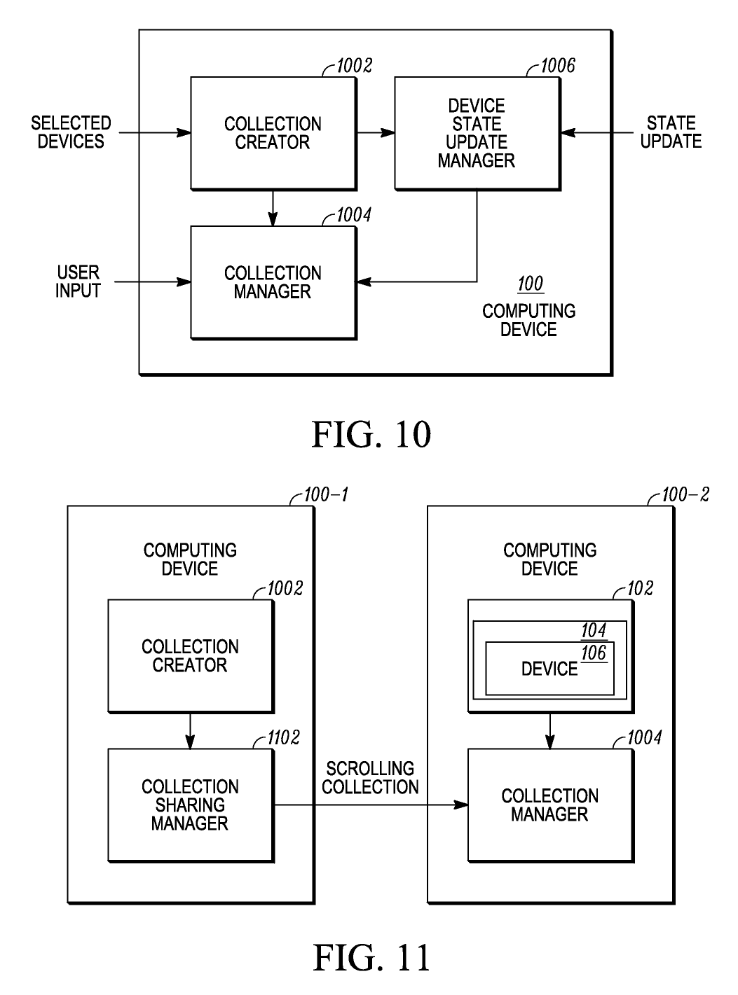

FIG. 10 depicts a more detailed example of computing device 100 according to one embodiment. A collection creator 1002 receives selected devices 106 for creating a scrolling collection. A grouping may also be received. Collection creator 1002 then creates the scrolling collection.

A collection manager 1004 may display devices 106 from the scrolling collection on user interface 102. For example, collection manager 1004 manages when to scroll to a new device 106. Collection manager 1004 may use a timer to determine when to scroll to a new device 106 or user input may be received to perform the scrolling.

A device state update manager 1006 receives an indication of which devices 106 are in the scrolling collection from collection creator 1002. Device state update manager 1006 receives the state updates for devices 106. State updates for the devices 106 in the scrolling collection are then forwarded to collection manager 1004. Collection manager 1004 manages the state for devices 106 in the collection. For example, the state may be continuously updated while devices 106 are in viewing area 104 or in the off-screen area. Collection manager 1004 may set up a stream in which state updates are automatically applied to devices 106 in the scrolling collection.

Users may also generate a scrolling collection on a first computing device 100 and send the scrolling collection to another computing device 100. FIG. 11 shows an example of distributing scrolling collections according to one embodiment. Computing devices 100 may be actual devices 106 that are being controlled. For example, a television may be used to create a scrolling collection or receive a scrolling collection. However, in other embodiments, computing device 100 may be a separate device 106 that is not being controlled. Computing device 100 will be used for discussion purposes, but computing device 100 may also mean device 106.

In a computing device 100-1, collection creator 1002 creates a scrolling collection of devices 106. A collection sharing manager 1102 sends the scrolling collection to a different computing device 100-2. For example, the user may create the scrolling collection and then select computing device 100-2 to share the scrolling collection. In one example, the user may use a cellular phone to create a scrolling collection and then send it to the user's television. The user may then view the collection on the television.

When computing device 100-2 receives the scrolling collection, a collection manager 1004 displays the scrolling collection on user interface 102. For example, a device 106 may be displayed in viewing area 104 of user interface 102.

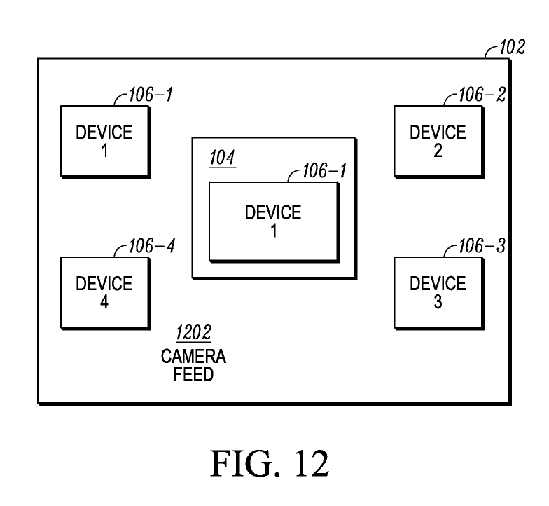

In another example, the grouping of the scrolling collection may be based on a camera feed. FIG. 12 shows an example of user interface 102 using a camera feed as a background according to one embodiment. A camera feed 1202 is shown in the background of user interface 102. For example, camera feed 1202 may be streaming video/audio of a current room that is included in a group of devices 106 that are in the scrolling collection. Camera feed 1202 shows various devices 106 in the group. For example, devices 106-1, 106-2, 106-3, and 106-4 are shown in camera feed 1202. A device 106-1 in the scrolling collection is shown in viewing area 104. For example, an icon of device 106-1 that allows the controlling of device 106-1 is displayed in viewing area 104.

The user may navigate among devices 106 that are shown in camera feed 1202. For example, the user may scroll to the right or left to view another device 106 in camera feed 1202. In one example, if the user scrolls to the right, device 106-2 is displayed in viewing area 104. The user can now control device 106-2. Also, if the user scrolls to the left, device 106-4 is displayed in viewing area 104 and the user can now control device 106-4. If the user wants to view another grouping, such as a grouping of devices 106 in another room, the user may scroll up or down. For example, if the user scrolls up, the scrolling collection moves from devices 106 in the living room to devices 106 in the bedroom. A new camera feed 1202 of the bedroom is shown and a scrolling collection of devices 106 in the bedroom is displayed in viewing area 104.

Accordingly, particular embodiments provide many advantages. For example, a simplified user interface 102 is provided to a user. The user can control devices 106 one at a time through the scrolling collection. Also, grouping is allowed to allow users to group similar devices 106 that are shown in the scrolling collection. Additionally, state updates of all devices 106 in the collection are provided such that up-to-date information that is needed to control devices 106 is provided when devices 106 are shown in viewing area 104.

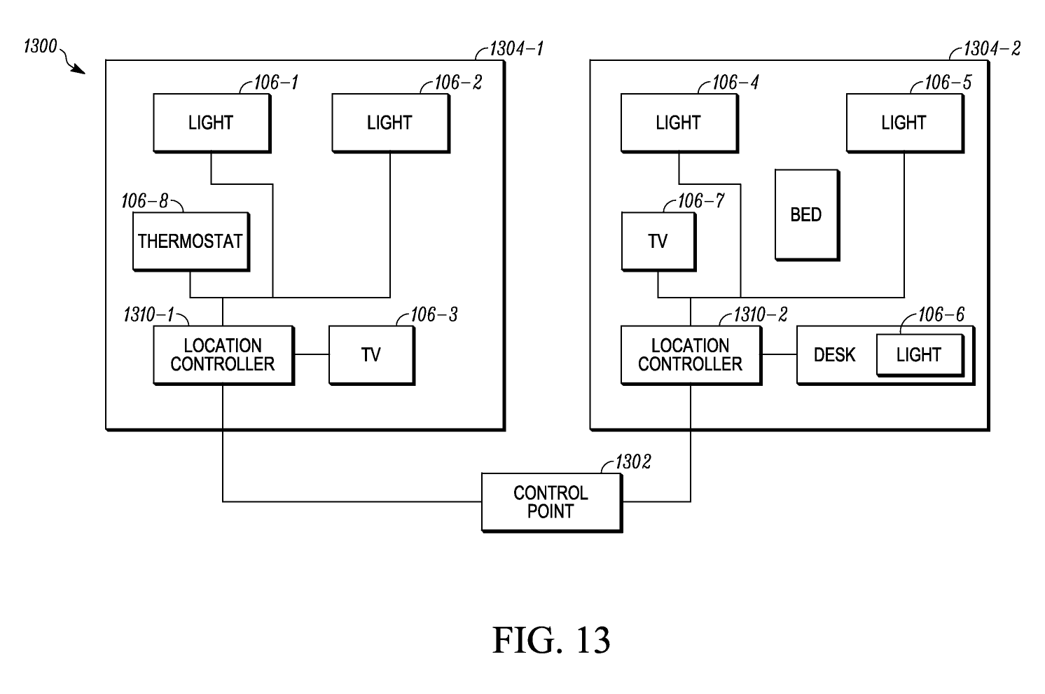

FIG. 13 depicts a simplified system 1300 according to one embodiment. As shown, control point 1302, and locations 1304 are provided. Locations 1304 also include devices 106, and location controller 1310.

Control point 1302 is configured to control items 108 in locations 1304. A location may be any area, such as a room, hallway, etc. System 1300 may be broken up into locations 1304. For example, the locations may be found in a house, business, or any other area. Although specific locations 1304 are described, it will be understood that any number of locations may be controlled using control point 1302.

Control point 1302 may include hardware, software, or any combination thereof to cause actions to be performed with devices 106. For example, devices 106 may be controlled by turning them off, turning them on, etc. via interface 102. When a control is applied, computing device 100 may send a command to control point 1302 to have the control applied to applicable devices 106. Control point 1302 communicates with location controller 1310 to have the control applied. In one embodiment, control point 1302 may communicate through a network to location controllers 110. Location controllers 1310 may then cause the actions to be performed with devices 106 that are in a specific location. For example, location controller 1310-1 may be able to control devices 106-1-106-7.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
receiving a selection of a set of devices;
generating a scrolling collection using the set of devices, the set of devices being available for control through an interface;
scrolling, by a computing device, through devices in the set of devices, wherein scrolling comprises:
determining a device in the set of devices;
determining a control for the determined device; and
displaying the determined device and the determined control on the interface, the determined device being controllable through the interface using the determined control while being displayed, wherein devices in the set of devices other than the displayed determined device are not displayed on the interface.

2. The method of claim 1, further comprising:
receiving a plurality of groupings of devices in the set of devices; and
performing the scrolling for devices in one of the plurality of groupings.

3. The method of claim 2, further comprising:
receiving a selection of another one of the plurality of groupings; and
performing the scrolling for devices in the another one of the plurality of groupings.

4. The method of claim 1, further comprising:
updating a state for devices in the set of devices that are not displayed on the interface.

5. The method of claim 1, further comprising:
updating a state for the displayed device; and
displaying the updated state for the displayed device on the interface.

6. The method of claim 1, wherein the updated state is based on a controlling of a physical or virtual device associated with the displayed device.

7. The method of claim 1, further comprising:
receiving a cluster command;
determining one or more devices in the set of devices not being displayed on the interface; and
displaying the one or more devices along with the displayed device already displayed on the interface.

8. The method of claim 1, further comprising displaying a characteristic of usage for the displayed device on the interface.

9. The method of claim 1, wherein controls for devices not displayed on the interface are not displayed with the determined control for the displayed device.

10. The method of claim 1, further comprising sending the scrolling collection to another computing device for display.

11. The method of claim 1, further comprising:
displaying a content feed of a location including the set of devices in a first area of the interface; and
displaying the determined device and the determined control in a second area of the interface.

12. The method of claim 11, further comprising:
receiving a command to move to another device displayed in the content feed;
and displaying the another device in the second area.

13. The method of claim 1, wherein scrolling comprises displaying a series of devices in the scrolling collection at a series of time intervals.

14. A non-transitory computer-readable storage medium containing instructions for controlling a computer system to be operable to:
receive a selection of a set of devices;
generate a scrolling collection using the set of devices, the set of devices being available for control through an interface;
scroll through devices in the set of devices, wherein scrolling comprises:
determine a device in the set of devices;
determine a control for the determined device; and
display the determined device and the determined control on the interface, the determined device being controllable through the interface using the determined control while being displayed, wherein devices in the set of devices other than the displayed determined device are not displayed on the interface.

15. The non-transitory computer-readable storage medium of claim 14, further operable to:
receive a plurality of groupings of devices in the set of devices; and
perform the scrolling for devices in one of the plurality of groupings.

16. The non-transitory computer-readable storage medium of claim 14, further operable to update a state for devices in the set of devices that are not displayed on the interface.

17. The non-transitory computer-readable storage medium of claim 14, further operable to:
update a state for the displayed device; and
display the updated state for the displayed device on the interface.

18. The non-transitory computer-readable storage medium of claim 14, wherein controls for devices not displayed on the interface are not displayed with the determined control for the displayed device.

19. The non-transitory computer-readable storage medium of claim 14, further operable to:
display a content feed of a location including the set of devices in a first area of the interface; and
display the determined device and the determined control in a second area of the interface.

20. An apparatus comprising:
one or more computer processors; and
a computer-readable storage medium comprising instructions for controlling the one or more computer processors to be operable to:
receive a selection of a set of devices;
generate a scrolling collection using the set of devices, the set of devices being available for control through an interface;
scroll through devices in the set of devices, wherein scrolling comprises:
determine a device in the set of devices;
determine a control for the determined device; and
display the determined device and the determined control on the interface, the determined device being controllable through the interface using the determined control while being displayed, wherein devices in the set of devices other than the displayed determined device are not displayed on the interface.
